(19) United States
(12) Patent Application Publication
(10) Pub. No.: US 2022/0147900 A1
(43) Pub. Date: May 12, 2022

(54) CONTINUOUS EMPLOYEE EXPERIENCE AND EFFICIENCY EVALUATION BASED ON COLLABORATION CIRCLES

(71) Applicant: Yva.ai, Inc., Santa Clara, CA (US)

(72) Inventors: David Yan, Portola Valley, CA (US); Victor Kuznetsov, Los Gatos, CA (US); Egor Vorogushin, Moscow (RU)

(21) Appl. No.: 17/523,537

(22) Filed: Nov. 10, 2021

Related U.S. Application Data
(60) Provisional application No. 63/112,304, filed on Nov. 11, 2020.

(51) Int. Cl. G06Q 10/06; G06Q 10/10

(52) U.S. Cl. CPC G06Q 10/06398; G06Q 10/107

(57) ABSTRACT

An example method of employee experience and efficiency evaluation based on the employee's collaboration circles comprises: identifying, by a computer system, based on processing a plurality of documents reflecting communications of a specified person, a collaboration circle of the specified person; generating, based on a set of previously collected responses reflecting experience and efficiency of the employee, a set of questions with respect to experience and efficiency of the employee; presenting the set of questions to a plurality of persons comprised by the collaboration circle; collecting responses to the set of questions from the plurality of persons comprised by the collaboration circle; and generating a dashboard reflecting the collected responses.

### REFERENCE TO RELATED APPLICATIONS

This application claims the benefit of U.S. Provisional Application No. 63/112,304 filed on Nov. 11, 2020, which is incorporated by reference herein.

### TECHNICAL FIELD

The present disclosure is generally related to computer systems, and is more specifically related to systems and methods of employee experience and efficiency evaluation based on the employee's collaboration circles.

### BACKGROUND

Employee experience and efficiency evaluation is an integral element of human resource management processes in many organizations. Various common experience and efficiency evaluation methods rely heavily on human-generated information, such as evaluation questionnaires, interview summaries, unstructured or weakly-structured feedback generated by the employee's supervisors, peers, and subordinates, etc.

### BRIEF DESCRIPTION OF THE DRAWINGS

The present disclosure is illustrated by way of examples, and not by way of limitation, and may be more fully understood with references to the following detailed description when considered in connection with the figures, in which:

FIG. 1 schematically illustrates an example employee experience and efficiency evaluation workflow implemented in accordance with one or more aspects of the present disclosure;

FIG. 2 schematically illustrates a high-level network diagram of a distributed computer systems in which the systems and methods of the present disclosure may be implemented;

FIG. 3 depicts a flow diagram of an example method of identifying employee's collaboration circles, in accordance with one or more aspects of the present disclosure;

FIG. 4 depicts a flow diagram of an example method of performing a smart survey, in accordance with one or more aspects of the present disclosure;

FIG. 5 depicts a flow diagram of another example method of performing a smart survey, in accordance with one or more aspects of the present disclosure;

FIG. 6 schematically illustrates an example high-level functional diagram of a computing system implementing smart surveys, in accordance with aspects of the present disclosure;

FIG. 7 depicts a flow diagram of an example method of employee experience and efficiency evaluation, in accordance with aspects of the present disclosure; and

FIG. 8 schematically illustrates a component diagram of an example computer system which may perform the methods described herein.

### DETAILED DESCRIPTION

Described herein are systems and methods for employee experience and efficiency evaluation based on the employee's collaboration circles.

Employee experience and efficiency evaluation are integral elements of human resource management processes in many organizations. Various experience and efficiency evaluation methods rely heavily on unstructured or weakly-structured feedback generated by the employee's supervisors, peers, and subordinates, etc. Apart from being highly subjective, such information requires considerable human effort to generate.

The present disclosure addresses the above-noted and other deficiencies of various employee experience and efficiency evaluation methods by providing methods of employee experience and efficiency evaluation based on the employee's collaboration circles. In some implementations, smart surveys are conducted periodically (e.g., on a weekly basis) and involve presenting to each employee a single questionnaire that includes at most a predefined number of questions that have been generated based on the responses received to one or more previous surveys. Most of the questions require selection from a closed list of responses (e.g., a value on the scale of 0-10, a binary response (yes/no), selection of a skill from a closed set of skills, selection of a team member from a list of team members, etc.) and thus are expected to require a di minimis time to complete (e.g., up to twelve questions that are expected to require no more three minutes of the respondent's time).

In some implementations, separate smart surveys, which may be distributed to same or different sets of respondents, may target one or more hyper-categories, such as employee experience, employee efficiency, etc. “Employee experience” herein refers to the employee's perception of various job-related factors affecting the employee's wellbeing, engagement, and satisfaction. “Employee efficiency” herein refers to various employee's characteristics and traits affecting the employee's performance, skills, and leadership.

Within each hyper-category, the survey questions may be classified into multiple categories. For example, employee experience surveys can include questions that are classified into wellbeing, engagement, and satisfaction categories. In another example, employee efficiency surveys can include questions that are classified into performance, skills, and leadership categories. Each survey category may include multiple sub-categories, each of which may in turn include multiple questions.

The smart survey system implemented in accordance with aspects of the present disclosure may identify, for a specified employee, her/his collaboration circles for a specified period (e.g., a moving time window). A collaboration circle is a list of persons (“collaborators”) with whom the specified employee has actually engaged in documented two-way communications (e.g., exchanged electronic mail messages) and/or is presumed to have collaborated based on the organizational structure. In an illustrative example, the identified collaborators may be asked to complete a survey that targets the efficiency and/or experience of the specified employee. In another illustrative example, the specified employee may be asked to complete a survey that targets the efficiency and/or experience of one or more members of the employee's collaboration circle.

As noted herein above, the smart survey questions are generated based on the responses received to one or more previous surveys. In an illustrative example, one or more focus areas can be identified as the survey categories or sub-categories that have received the lowest aggregated response values or the lowest number of responses in one or more previous surveys, and the questions for the next survey can predominantly be selected from these survey categories or sub-categories. In another illustrative example, one or more focus employees can be identified as the employees that received the lowest aggregated response values or the lowest number of responses in one or more categories of sub-categories of one or more previous surveys, and the questions for the next survey to be asked without respect to the identified focus employees can predominantly be selected from these survey categories or sub-categories.

The smart survey system processes the received responses and identifies areas and/or organizational units requiring further attention, low performing employees, employees exhibiting low job satisfaction, employees exhibiting high burnout characteristics, employees that are likely to resign in the immediate future, and/or various other organizational characteristics and parameters, which can be delivered to the management team of the organization via one or more managerial dashboards.

In some implementations, the smart survey system may further processes the received responses and generate personalized feedback for each employee. The feedback may reflect various aspects of the employee's performance, skills, and leadership.

Thus, the systems and methods described herein may be efficiently utilized for evaluating employee experience and efficiency based on the responses to smart survey questions by members of the employee's collaboration circles. Advantages of the systems and methods of the present disclosure over various common survey-based approaches include higher survey participation rates that are driven by a regular personalized feedback provided to each employee in the form of one or more dashboards. Further advantages of the systems and methods of the present disclosure include keeping at very low levels the effort required to complete each survey, which results in a low attrition rate among survey participants.

The systems and methods described herein may be implemented by hardware (e.g., general purpose and/or specialized processing devices, and/or other devices and associated circuitry), software (e.g., instructions executable by a processing device), or a combination thereof. Various aspects of the methods and systems are described herein by way of examples, rather than by way of limitation. In particular, certain specific examples are referenced and described herein for illustrative purposes only and do not limit the scope of the present disclosure.

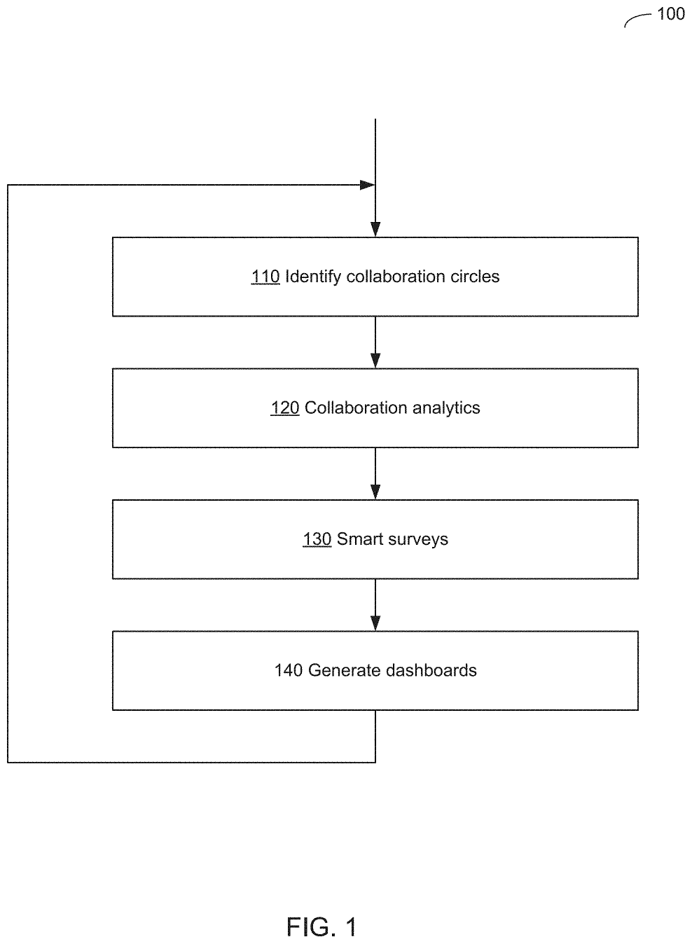

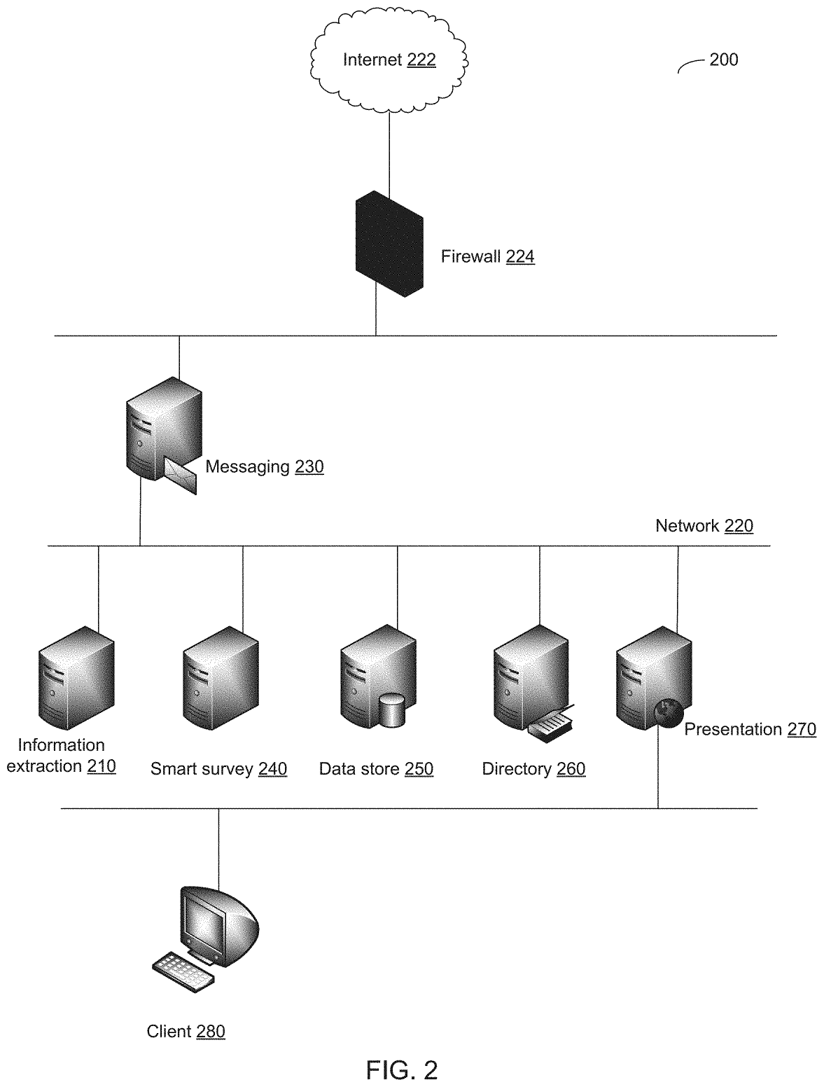

FIG. 1 schematically illustrates an example employee experience and efficiency evaluation workflow 100 implemented in accordance with aspects of the present disclosure. Workflow 100 and/or each of its individual functions, routines, subroutines, or operations may be performed by one or more processors of the computer system (e.g., the information extraction server 210 and/or efficiency evaluation server 240 of FIG. 2) implementing the workflow.

At operation 110, the computer system implementing the workflow identifies collaboration circles of a specified employee. In an illustrative example, the computer system may process a set of structured communications 112 (e.g., electronic mail messages, instant messages, and/or voicemail transcriptions) to identify one or more collaborators, i.e., persons with whom the specified employee has regularly exchange communications within a specified time period. The computer system may further process the organizational chart of the employee's organization in order to identify one or more presumed collaborators, i.e., managers, peers, and/or subordinates of the employee. The two lists may then be merged in order to produce a final list of collaborators of the specified employee, as described in more detail herein below.

At operation 120, the computer system analyzes at least a subset of the structured communications 112 (e.g., electronic mail messages, instant messages, and/or voicemail transcriptions) of the specified employee and the identified collaborators, in order to evaluate individual and group experience and efficiency, as described in more detail herein below.

At operation 130, the computer system generates a set of questionnaires designed to evaluate the employee's experience and efficiency. Each questionnaire includes at most a predefined number of questions to be answered by one or more identified collaborators of the specified employee. The questions are at least in part based on the information that was received in response to the previously circulated questionnaires evaluating the experience and efficiency of the specified employee and/or other employees within the same organizational unit and/or within the same organization. “Organizational unit” herein shall refer to a subdivision of a hierarchical structure representing the organization (e.g., a subtree of a tree representing the organization, departments, individual employees, etc.).

In some implementations, the questions can be at least in part based upon the information extracted at operation 120 from the employee's structured communications. In some implementations, the computer system may aggregate, into a single questionnaire, all questions directed to a given employee with respect to all his/her collaborators. Thus, each employee would be expected to respond to a single questionnaire including no more than a predefined small number of questions (e.g., 10-15), which is tailored to be below the level of burden that would trigger drop in the participation rate, as described in more detail herein below.

At operation 140, the computer system processes the responses to the questionnaires and generates dashboards that visually represent the employee experience and efficiency. In some implementations, one or more generated dashboards may be presented to the employee whose efficiency has been evaluated, while other generated dashboards may be presented to the management of the organization. In some implementations, one or more generated dashboards that are addressed to individual employees can include suggestions on skills to develop, areas to concentrate upon, etc., as described in more detail herein below. In some implementations, one or more generated dashboards that are addressed to the management team can identify organizational units requiring further attention, low performing employees, employees exhibiting low job satisfaction, employees exhibiting high burnout characteristics, employees that are likely to resign in the immediate future, and/or various other organizational characteristics and parameters.

Operations 110-140 may be periodically performed for one or more employees of one or more organizational units (e.g., departments) of an organization (e.g., a corporation), such that the questionnaires and generated, distributed, and processed at a predefined frequency (e.g., weekly), thus providing up-to-date information to the employees and the management of the organization, who can review the information and take the necessary corrective actions.

FIG. 2 schematically illustrates a high-level network diagram of a distributed computer system in which the systems and methods of the present disclosure may be implemented. As schematically illustrated by FIG. 2, the distributed computer system 200 may comprise the information extraction server 210 which may communicate, over one or more network segments 220 (which may be connected to the Internet 222 via a firewall 224), with the corporate messaging server (e.g., electronic mail and/or instant messaging server) 230, smart survey server 240, data store 250, directory server 260, presentation server 270, one or more client computers 280, and various other computers connected to the distributed computer system 200. Employing a distributed computer system (e.g., the example distributed computer system 200) for analyzing the structured communications, generating collaboration circles, generating smart survey questions, processing the responses, and/or performing various other functions of the methods described herein allows efficiently solving the above-listed and other tasks which may exhibit very high computational complexity due to the high numbers and/or volume of structured communications being processed, as well as due to the fact that a number of potential direct communications of a specified person grows exponentially with the size of the organization.

The information extraction server 210 may process a set of structured communications (e.g., electronic mail messages, instant messages, and/or voicemail transcriptions) to identify the collaboration circles of a specified employee. In some implementations, in identifying the collaboration circles, the collaboration information extraction server 210 may further utilize the information extracted from one or more organizational structure charts stored by the corporate directory server 260. In some implementations, the information extraction server 210 may further analyze at least a subset of the structured communications of the specified employee and the identified collaborators, in order to evaluate individual and group experience and efficiency, as described in more detail herein below.

The smart survey server 240 generates a set of questionnaires designed to evaluate the employee's experience and efficiency. The questions are at least in part based on the information that was received in response to the previously circulated questionnaires evaluating the experience and efficiency of the specified employee and/or other employees within the same organizational unit and/or within the same organization. In some implementations, the questions can be at least in part based upon the information extracted by the information extraction server 210 from the employee's structured communications, as described in more detail herein below.

The presentation server 270 generates and delivers, to client computers 280, visual representations of the surveys and dashboards. In some implementations, one or more generated dashboards may be presented to the employee whose efficiency has been evaluated, while other generated dashboards may be presented to the management of the organization, as described in more detail herein below.

It should be noted that the functional designations of the servers shown in FIG. 2 are for illustrative purposes only; in various alternative implementations, one or more functional components may be collocated on a single physical server and/or a single functional component may be implemented by two or more physical servers. Furthermore, various network infrastructure components, such as firewalls, load balancers, network switches, etc., may be omitted from FIG. 2 for clarity and conciseness. Computer systems, servers, clients, appliances, and network segments are shown in FIG. 2 for illustrative purposes only and do not in any way limit the scope of the present disclosure. Various other computer systems, servers, clients, infrastructure components, appliances, and/or methods of their interconnection may be compatible with the methods and systems described herein

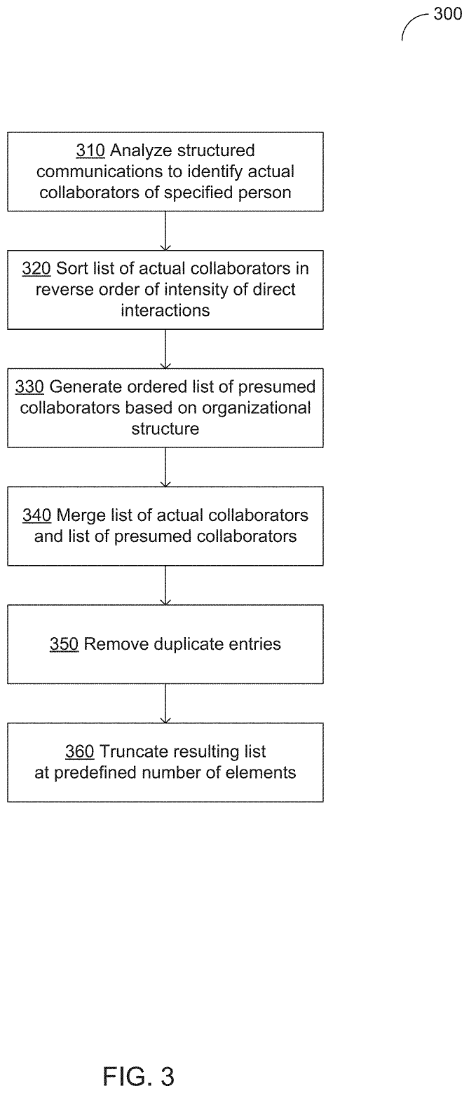

FIGS. 3-5 illustrate flowcharts of example methods of implementing various operations of the example employee experience and efficiency evaluation workflow 100. In some implementations of the workflow 100, various other methods implementing its operations functions may be employed.

In particular, FIG. 3 depicts a flow diagram of an example method 300 of identifying employee's collaboration circles, in accordance with one or more aspects of the present disclosure. Method 300 and/or each of its individual functions, routines, subroutines, or operations may be performed by one or more processors of the computer system (e.g., the information extraction server 210 and/or smart survey server 240 of FIG. 2) implementing the method. In certain implementations, method 300 may be performed by a single processing thread. Alternatively, method 300 may be performed by two or more processing threads, each thread executing one or more individual functions, routines, subroutines, or operations of the method. In an illustrative example, the processing threads implementing method 300 may be synchronized (e.g., using semaphores, critical sections, and/or other thread synchronization mechanisms). Alternatively, the processing threads implementing method 300 may be executed asynchronously with respect to each other.

At block 310, the computer system implementing the method processes a plurality of documents which record communications of a specified employee in order to identify direct interactions of the specified employee with other persons (“collaborators”) within and/or outside of a specified organizational perimeter. In various illustrative examples, the plurality of documents may include electronic mail messages, instant messages, and/or voicemail transcriptions. “Direct interaction” herein refers to a message exchange (e.g., one or more pairs of messages, such that each pair includes a request and a response). In some implementations, the computer system may employ natural language processing methods (e.g., neural networks) to analyze the content of the messages in order to exclude irrelevant (e.g., private communications, messages reflecting trivial business interactions such as travel bookings, etc.) messages from consideration. In some implementations, analyzing the content of messages may involve identifying specific semantic constructs (e.g., a task being formulated by a manager to a subordinate, or a status being reported by a subordinate to a manager), which would increase the relevance factor of the respective messages.

In some implementations, the computer system may further determine the level of sentiments expressed by an employee and/or members of the employee's collaboration cicles with respect to the progress, completion status, and/or quality of a work product associated with an identified task. In an illustrative example, the level of sentiments may be represented by a value indicating a “positive,” “neutral,” or “negative” sentiment; in another illustrative example, the level of sentiments may be represented by a numeric value on a pre-defined scale.

In an illustrative example, each input document (e.g., an electronic mail message, an instant message, or a voicemail transcript) may be represented by a vector of features, which are derived from the terms extracted from the document body and/or document metadata. Accordingly, a named entity extraction pipeline may be employed to extract the named entities from To:, Cc:, and/or From: fields of the set of structured communications. In certain implementations, another named entity extraction pipeline may be employed to extract the named entities from the body and/or subject line of the electronic messages. In certain implementations, yet another extraction pipeline may be employed for extracting document timestamps, priority and/or importance indicators, and/or various other metadata. A separate extraction pipelines may analyze the message bodies. Each of the extraction pipelines may utilize trainable classifiers, production rules, neural networks, statistical methods and/or their various combinations.

In an illustrative example, the computer system may employ rule-based information extraction methods, which may apply a set of production rules to a graph representing syntactic and/or semantic structure of the input text. The production rules may interpret the graph and yield definitions of information objects referenced by tokens of the input text and identify various relationships between the extracted information objects. In an illustrative example, the left-hand side of a rule may include a set of logical expressions defined on one or more templates applied to the graph representing the input text. The template may reference one or more lexical structure elements (e.g., a certain grammeme or semanteme etc.), syntactic structure elements (e.g., a surface or deep slot) and/or semantic structure elements (e.g., an ontology concept). Matching the template defined by the left-hand side of the rule to at least a part of the graph representing the input text triggers the right-hand side of the rule, which associates one or more attributes (e.g., an ontology concept) with an information object referenced by a token of the input text.

At block 320, the computer system sorts the identified actual collaborators in the reverse order of the intensity of direct interactions (e.g., represented by the number of pairs of messages exchanged) with the specified employee. In some implementations, the resulted sorted list may be truncated at a predefined maximum number of actual collaborators.

At block 330, the computer system analyzes the organizational structure and generates an ordered list of presumed collaborators of the specified employee. In some implementations, the list may include the direct manager of the specified employee, no more than a predefined number subordinates of the specified employee listed in a random order (starting with the direct subordinates and adding indirect subordinates if the number of direct subordinates is less than the predefined number), and no more than a predefined number of subordinates of the direct manager listed in a random order. In some implementations, the resulted sorted list may be truncated at a predefined maximum number of presumed collaborators.

At block 340, the computer system merges the two lists while keeping the ordering.

At block 350, the computer system removes any duplicate entries from the merged list.

At block 350, the computer system truncates the resulting list to a predefined number of entries. The resulting list is referred to as a “collaboration circle” of the specified employee, which can be utilized for conducting a smart survey evaluating the employee experience and efficiency.

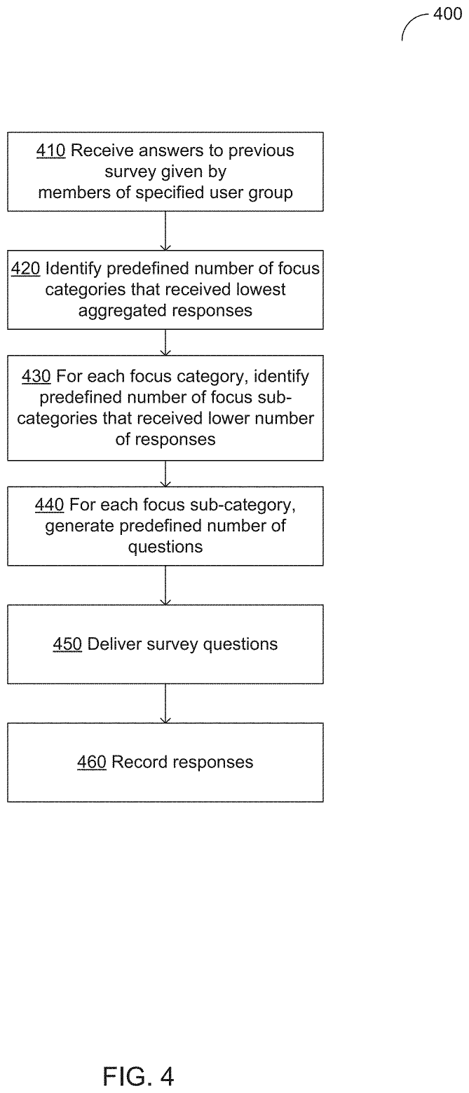

FIG. 4 depicts a flow diagram of an example method 400 of performing a smart survey, in accordance with one or more aspects of the present disclosure. Method 400 and/or each of its individual functions, routines, subroutines, or operations may be performed by one or more processors of the computer system (e.g., the information extraction server 210 and/or smart survey server 240 of FIG. 2) implementing the method. In certain implementations, method 400 may be performed by a single processing thread. Alternatively, method 400 may be performed by two or more processing threads, each thread executing one or more individual functions, routines, subroutines, or operations of the method. In an illustrative example, the processing threads implementing method 400 may be synchronized (e.g., using semaphores, critical sections, and/or other thread synchronization mechanisms). Alternatively, the processing threads implementing method 400 may be executed asynchronously with respect to each other.

At block 410, the computer system implementing the method retrieves the answers to a previous survey of a specified hyper-category (e.g., employee experience) that were given by members of a specified user group (e.g., the organizational unit to which a specified user belongs or is otherwise associated with).

At block 420, the computer system identifies a predefined number of categories of the specified hyper-category (e.g., employee experience) which received the lowest aggregated (e.g., averaged over all respondents) response value in the previous survey, assuming that the responses are either binary (where “no” is translated to “0” and “yes” is translated to “1”) or numeric values from a predefined scale (e.g., 1 to 10). The identified categories are referred to as “focus” categories.

At block 430, the computer system identifies, for each focus category, a predefined number of subcategories which received the lowest, among all subcategories of the respective focus category, number of answered questions in the previous survey. The identified sub-categories are referred to as “focus” sub-categories.

At block 440, the computer system generates, for each focus sub-category, a predefined number of questions, such that the total number of generated questions would not exceed a predefined maximum threshold number of questions. In an illustrative example, the questions may be selected randomly from each identified focus sub-category. In another illustrative example, the questions from each identified focus sub-category may be selected based on sub-category specific ordering of questions. In yet another illustrative example, for each identified focus sub-category, the questions that have received the lowest number of answers in the previous survey may be selected.

At block 450, the computer system delivers the generated questions to the identified collaborators (e.g., to the members of the specified group). In some implementations, the questions may be presented to the identified collaborators via a graphical user interface.

At block 460, the computer system records the received responses to the survey questions. In some implementations, the responses may be stored in one or more files and/or database tables. In an illustrative example, the responses can be represented by a rectangular matrix, each row of which corresponds to an employee, and each column corresponds to a survey question. The rows may be further grouped by organizational units, while the columns may be further grouped by survey categories and sub-categories. Accordingly, the matrix element found the intersection of a specified row and a specified column would store a response (e.g., a numeric value) given by an employee identified by the index of the row to the survey question identified by the index of the column.

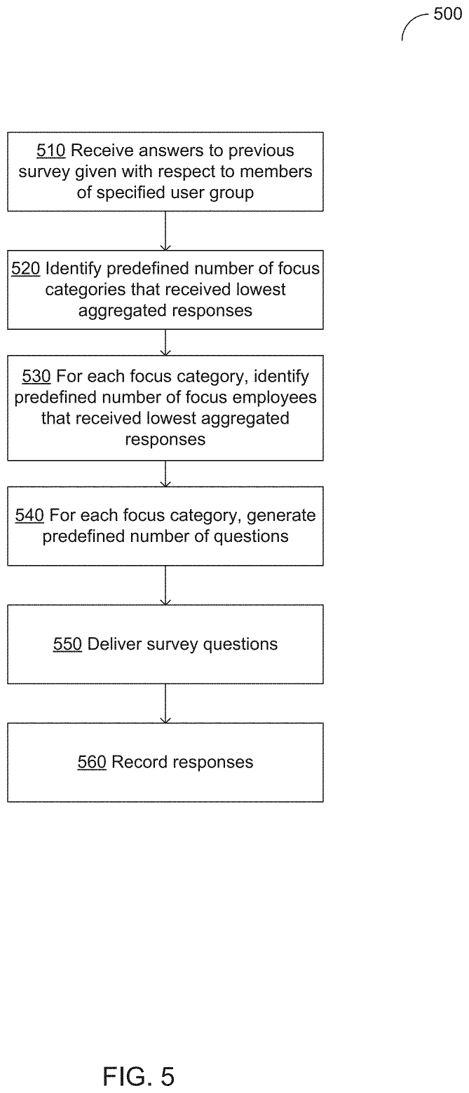

FIG. 5 depicts a flow diagram of another example method 500 of performing a smart survey, in accordance with one or more aspects of the present disclosure. Method 500 and/or each of its individual functions, routines, subroutines, or operations may be performed by one or more processors of the computer system (e.g., the information extraction server 210 and/or smart survey server 250 of FIG. 2) implementing the method. In certain implementations, method 500 may be performed by a single processing thread. Alternatively, method 500 may be performed by two or more processing threads, each thread executing one or more individual functions, routines, subroutines, or operations of the method. In an illustrative example, the processing threads implementing method 500 may be synchronized (e.g., using semaphores, critical sections, and/or other thread synchronization mechanisms). Alternatively, the processing threads implementing method 500 may be executed asynchronously with respect to each other.

At block 510, the computer system implementing the method retrieves the answers to a previous survey of a specified hyper-category (e.g., employee efficiency) that were received with respect to members of a specified user group (e.g., the organizational unit to which a specified user belongs or is otherwise associated with).

At block 520, the computer system identifies a predefined number of survey categories which received the lowest aggregated (e.g., averaged over all employees of a specified user group, such as an organizational unit) response values in the previous survey, assuming that the responses are either binary (where “no” is translated to “0” and “yes” is translated to “1”) or numeric values from a predefined scale (e.g., 0 to 10). The identified categories are referred to as “focus” categories.

At block 530, the computer system identifies, for each focus category, a predefined number of employees who have received lowest aggregated (e.g., averaged over all targeted employees) response values in the focus category. The identified employees are referred to as “focus” employees.

At block 540, the computer system generates, for each of one or more sub-categories in the identified focus category, a predefined number of questions, such that the total number of generated questions would not exceed a predefined maximum threshold number of questions. In an illustrative example, the questions may be selected randomly from each of one or more chosen sub-categories. In another illustrative example, the questions from each chosen sub-category may be selected based on sub-category specific ordering of questions. In yet another illustrative example, for each chosen sub-category, the questions that have received the lowest number of answers in the previous survey may be selected.

At block 550, the computer system delivers the generated questions to members of the collaboration circle of each focus employee. In some implementations, the questions may be presented to the identified collaborators via a graphical user interface.

At block 560, the computer system records the received responses to the survey questions. In some implementations, the responses may be stored in one or more files and/or database tables. In an illustrative example, the collected responses can be represented by a rectangular matrix, each row of which corresponds to an employee, and each column corresponds to a survey question. The rows may be further grouped by organizational units, while the columns may be further grouped by survey categories and sub-categories. Accordingly, the matrix element found the intersection of a specified row and a specified column would store an aggregated response (e.g., a numeric value) given about a particular attribute (e.g., skill, a trait, a characteristic) of an employee identified by the index of the row, such that the attribute is identified by the index of the column.

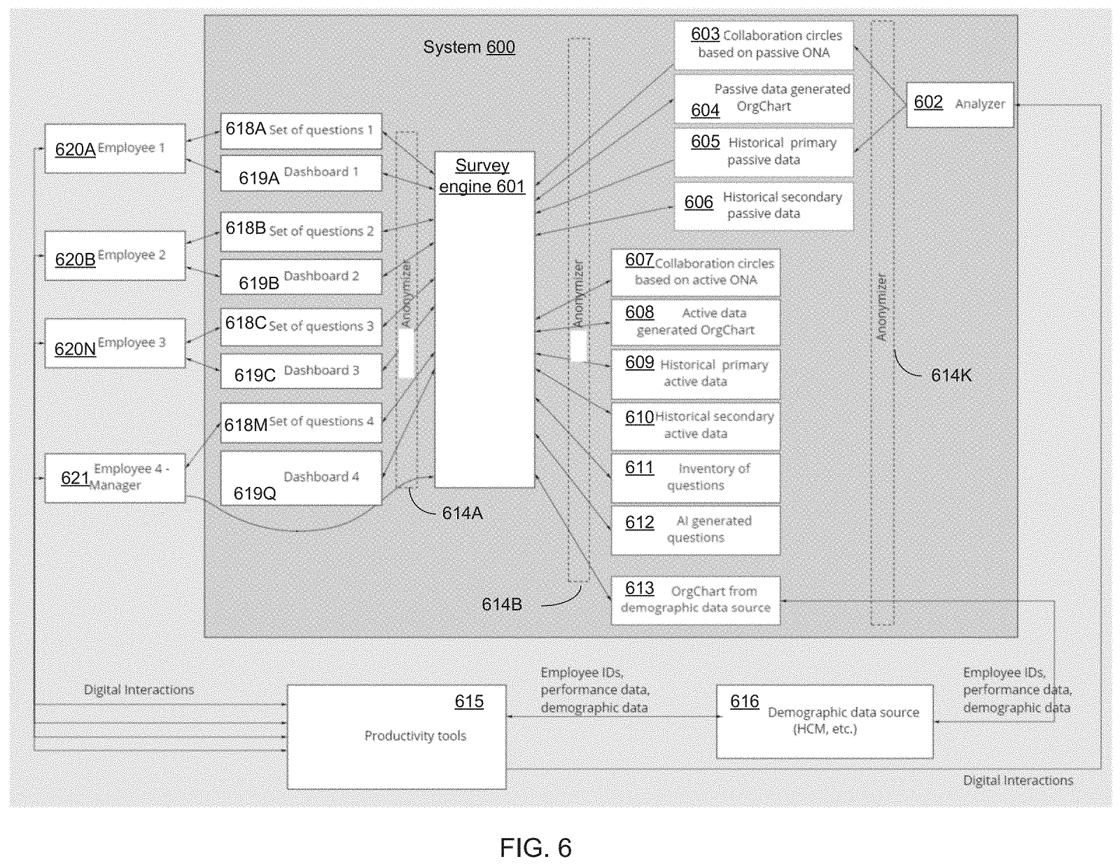

FIG. 6 schematically illustrates an example high-level functional diagram of a computing system 600 implementing smart surveys, in accordance with aspects of the present disclosure. As schematically shown in FIG. 6, the survey engine 601 receives data from other components of the system, including modules 603-606, etc., generates smart survey questions, receives and processes responses given by the respondents, and updates the data items 607-612.

Analyzer 602 collects and processes digital interactions from productivity tools and feeds the relevant data to the collaboration circle generator 603 and historic primary passive data module 605.

The collaboration circle generator 603 receives information from the analyzer 602 and defines the collaboration circles for a specified employee, e.g., by implementing the example method 300 described herein.

The organizational chart data 604 includes organizational chart data extracted from various data sources by organization network analysis methods. “Organizational chart” herein refers to a data structure including one or more hierarchically ordered lists of employees of an organization or one or more organizational units.

The historic primary passive data module 605 stores the historical digital interaction data extracted from structured communications. The data can include the digital workday length, response rate, response to request ratio, number of inbound and outbound messages, activity indexes, etc.

The historical secondary passive data module 606 stores the historical data extracted from the historical primary active data. The historical secondary passive data may identify tasks, conflicts, sentiments, characterize employee burnout, predict employee resignation, etc.

Historical secondary passive data 607 Creates collaboration circles based on answers from the employees, e.g. “please select the employees you have been working with last 2 weeks”

Active data generated Orgchart 608 Organizational chart created from answers of the employees, e.g.: “please select your direct managers”, “please select your direct reports”

Historical primary active data 609 Stores historical answers from the employees

Historical secondary active data 610 Stores historical data based on intelligent processing, content intelligence, process intelligence results on the historical answers from employees

Inventory of questions 611 stores the survey questions classified into categories and sub-categories. Within each sub-category, the questions may be ordered to reflect their relative importance, probative value, and/or other characteristics.

Artificial Intelligence (AI)-based question generator 612 receives information from the survey engine 101 and generates relevant questions using advanced language generative models.

Organizational chart module 613 creates one or more organizational charts by extracting information from human resource management systems and/or other relevant data sources.

Anonymizers 614A-614K strip, from structured communications, any personal identifying information, such as employee names, email addresses, etc. and substitute the stripped information with respective hash values.

Corporate productivity tools 615 include messaging and other communication applications and/or tools.

Demographic data source 616 represents demographic data of the employees, which may be extracted, e.g., from a human resource management system.

Sets of questions 618A-618M is a collection of questions that are to be answered by the survey respondents.

Dashboards 618A-618Q represent a set of personalized employee dashboards, in which every employee can see various data reflecting her/his experience, efficiency, skill set, improvement areas, and aggregated feedback provided by the employee's collaboration circles.

Employees 620A-620N are the members of the organization. Each employee can be associated with one or more organizational units. Each employee can be engaged in one or more hierarchical relationships (e.g., manager-subordinate) with one or more other employees.

Manager 621 is a member of the organization who plays a supervisory role with respect to one or more employees of one or more organizational units.

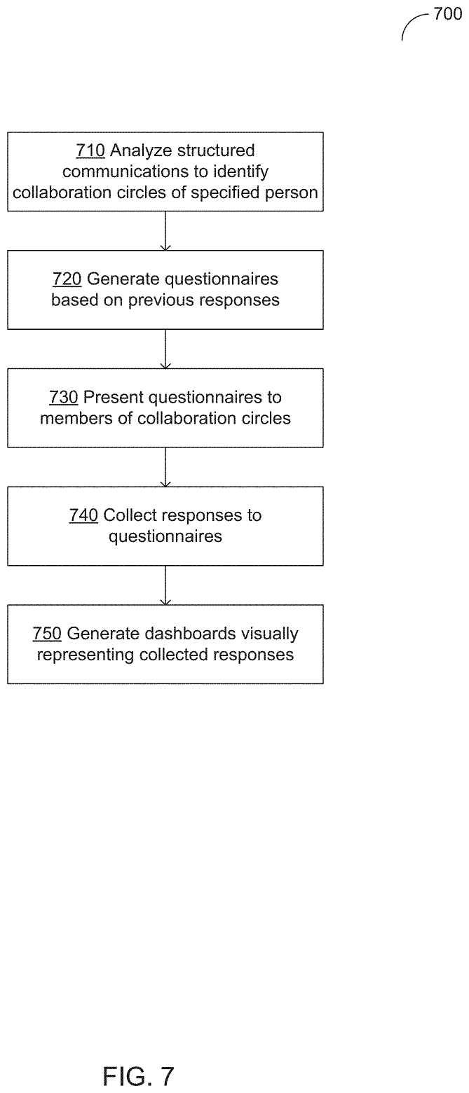

FIG. 7 depicts a flow diagram of another example method 700 of performing a smart survey, in accordance with one or more aspects of the present disclosure. Method 700 and/or each of its individual functions, routines, subroutines, or operations may be performed by one or more processors of the computer system (e.g., the information extraction server 210 and/or smart survey server 270 of FIG. 2) implementing the method. In certain implementations, method 700 may be performed by a single processing thread. Alternatively, method 700 may be performed by two or more processing threads, each thread executing one or more individual functions, routines, subroutines, or operations of the method. In an illustrative example, the processing threads implementing method 700 may be synchronized (e.g., using semaphores, critical sections, and/or other thread synchronization mechanisms). Alternatively, the processing threads implementing method 700 may be executed asynchronously with respect to each other.

At block 710, the computer system implementing the method processes a plurality of documents reflecting structured communications of a specified person (e.g., a specified employee of an organization) to identify a collaboration circle of the specified person. In various illustrative examples, the documents may include electronic mail messages, instant messages, and/or voicemail transcriptions stored by a corporate messaging server. In some implementations, identifying the collaboration circle may involve generating a list of actual collaborators by analyzing the plurality of documents reflecting communications of the specified person, identifying one or more presumed collaborators of the specified person by analyzing an organizational structure, merging the list of actual collaborators and the list of presumed collaborators, and truncating the final list to a predefined size, as described in more detail herein above.

At block 720, the computer system generates, based on previously collected responses reflecting experience and efficiency of the employee, one or more questionnaires for determining experience and efficiency of the employee. In an illustrative example, generating a list of questions for a questionnaire may involve identifying the category which received a lowest aggregated response value in one or more previous surveys, identifying a predefined number of subcategories of the identified category which have received lowest, among all sub-categories, numbers of answered questions in the previous survey, and generating a predefined number of survey questions in the identified sub-category. In another illustrative example, generating a list of questions for a questionnaire may involve identifying a predefined number of survey categories which have received lowest aggregated response values in a previous survey, identifying a predefined number of employees which have received lowest aggregated response values in each identified categories, and generating a predefined number of survey questions in each of the identified sub-categories, as described in more detail herein above.

At block 730, the computer system presents the questionnaires to the members of the employee's collaboration circle.

At block 740, the computer system collects responses to the questionnaires from the members of the employee's collaboration circle.

At block 750, the computer system generates one or more dashboards reflecting the collected responses. In an illustrative example, one or more generated dashboards may visually represent a set of employee experience parameters for a chosen organizational unit. In another illustrative example, one or more generated dashboards may visually represent a set of employee efficiency parameters for a chosen organizational unit. In yet another illustrative example, one or more generated dashboards may visually represent a set of employee skills and corresponding skill levels of a specified employee based on responses by one or more members of the collaboration circles. In yet another illustrative example, one or more generated dashboards may visually represent a set of employee leadership traits and corresponding leadership trait levels of the specified person based on responses by one or more members of the collaboration circles.

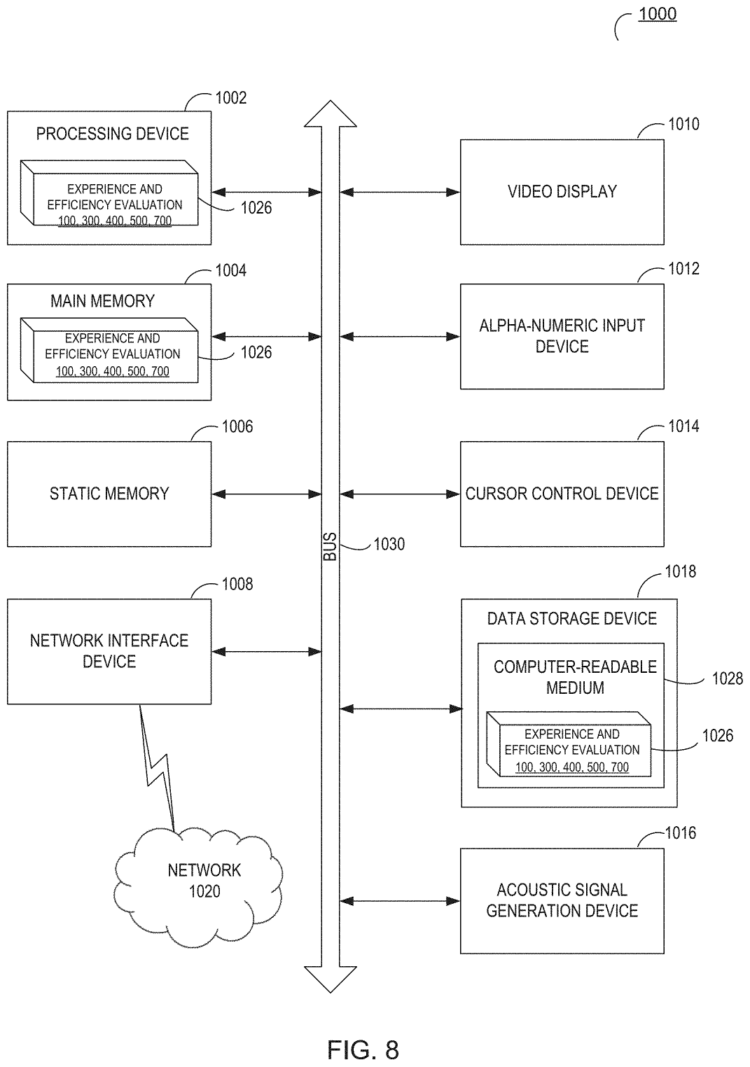

FIG. 8 schematically illustrates a component diagram of an example computer system 1000 which may perform the methods described herein. Example computer system 1000 may be connected to other computer systems in a LAN, an intranet, an extranet, and/or the Internet. Computer system 1000 may operate in the capacity of a server in a client-server network environment. Computer system 1000 may be a personal computer (PC), a set-top box (STB), a server, a network router, switch or bridge, or any device capable of executing a set of instructions (sequential or otherwise) that specify actions to be taken by that device. Further, while only a single example computer system is illustrated, the term “computer” shall also be taken to include any collection of computers that individually or jointly execute a set (or multiple sets) of instructions to perform any one or more of the methods discussed herein.

Example computer system 1000 may comprise a processing device 1002 (also referred to as a processor or CPU), a main memory 1004 (e.g., read-only memory (ROM), flash memory, dynamic random access memory (DRAM) such as synchronous DRAM (SDRAM), etc.), a static memory 1006 (e.g., flash memory, static random access memory (SRAM), etc.), and a secondary memory (e.g., a data storage device 1018), which may communicate with each other via a bus 1030.

Processing device 1002 represents one or more general-purpose processing devices such as a microprocessor, central processing unit, or the like. More particularly, processing device 1002 may be a complex instruction set computing (CISC) microprocessor, reduced instruction set computing (RISC) microprocessor, very long instruction word (VLIW) microprocessor, processor implementing other instruction sets, or processors implementing a combination of instruction sets. Processing device 1002 may also be one or more special-purpose processing devices such as an application specific integrated circuit (ASIC), a field programmable gate array (FPGA), a digital signal processor (DSP), network processor, or the like. In accordance with one or more aspects of the present disclosure, processing device 1002 may be configured to execute instructions implementing example workflow 100 and associated methods 300, 400, 500, and/or 700, in accordance with one or more aspects of the present disclosure.

Example computer system 1000 may further comprise a network interface device 1008, which may be communicatively coupled to a network 1020. Example computer system 1000 may further comprise a video display 1010 (e.g., a liquid crystal display (LCD), a touch screen, or a cathode ray tube (CRT)), an alphanumeric input device 1012 (e.g., a keyboard), a cursor control device 1014 (e.g., a mouse), and an acoustic signal generation device 1016 (e.g., a speaker).

Data storage device 1018 may include a computer-readable storage medium (or more specifically a non-transitory computer-readable storage medium) 1028 on which is stored one or more sets of executable instructions 1026. In accordance with one or more aspects of the present disclosure, executable instructions 1026 may comprise executable instructions encoding various functions of example workflow 100 and associated methods 300, 400, 500, and/or 700, in accordance with one or more aspects of the present disclosure.

Executable instructions 1026 may also reside, completely or at least partially, within main memory 1004 and/or within processing device 1002 during execution thereof by example computer system 1000, main memory 1004 and processing device 1002 also constituting computer-readable storage media. Executable instructions 1026 may further be transmitted or received over a network via network interface device 1008.

While computer-readable storage medium 1028 is shown in FIG. 8 as a single medium, the term “computer-readable storage medium” should be taken to include a single medium or multiple media (e.g., a centralized or distributed database, and/or associated caches and servers) that store the one or more sets of VM operating instructions. The term “computer-readable storage medium” shall also be taken to include any medium that is capable of storing or encoding a set of instructions for execution by the machine that cause the machine to perform any one or more of the methods described herein. The term “computer-readable storage medium” shall accordingly be taken to include, but not be limited to, solid-state memories, and optical and magnetic media.

Some portions of the detailed descriptions above are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise, as apparent from the following discussion, it is appreciated that throughout the description, discussions utilizing terms such as “identifying,” “determining,” “storing,” “adjusting,” “causing,” “returning,” “comparing,” “creating,” “stopping,” “loading,” “copying,” “throwing,” “replacing,” “performing,” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Examples of the present disclosure also relate to an apparatus for performing the methods described herein. This apparatus may be specially constructed for the required purposes, or it may be a general purpose computer system selectively programmed by a computer program stored in the computer system. Such a computer program may be stored in a computer readable storage medium, such as, but not limited to, any type of disk including optical disks, CD-ROMs, and magnetic-optical disks, read-only memories (ROMs), random access memories (RAMs), EPROMs, EEPROMs, magnetic disk storage media, optical storage media, flash memory devices, other type of machine-accessible storage media, or any type of media suitable for storing electronic instructions, each coupled to a computer system bus.

The methods and displays presented herein are not inherently related to any particular computer or other apparatus. Various general purpose systems may be used with programs in accordance with the teachings herein, or it may prove convenient to construct a more specialized apparatus to perform the required method steps. The required structure for a variety of these systems will appear as set forth in the description below. In addition, the scope of the present disclosure is not limited to any particular programming language. It will be appreciated that a variety of programming languages may be used to implement the teachings of the present disclosure.

It is to be understood that the above description is intended to be illustrative, and not restrictive. Many other implementation examples will be apparent to those of skill in the art upon reading and understanding the above description. Although the present disclosure describes specific examples, it will be recognized that the systems and methods of the present disclosure are not limited to the examples described herein, but may be practiced with modifications within the scope of the appended claims. Accordingly, the specification and drawings are to be regarded in an illustrative sense rather than a restrictive sense. The scope of the present disclosure should, therefore, be determined with reference to the appended claims, along with the full scope of equivalents to which such claims are entitled.

What is claimed is:

1. A method, comprising:
identifying, by a computer system, based on processing a plurality of documents reflecting communications of a specified person, a collaboration circle of the specified person;
generating, based on a set of previously collected responses reflecting experience and efficiency of the employee, a set of questions with respect to experience and efficiency of the employee;
presenting the set of questions to a plurality of persons comprised by the collaboration circle;
collecting responses to the set of questions from the plurality of persons comprised by the collaboration circle; and
generating a dashboard reflecting the collected responses.

2. The method of claim 1, wherein the plurality of documents comprises a plurality of electronic mail messages.

3. The method of claim 1, wherein identifying the collaboration circle further comprises:
generating a list of actual collaborators by analyzing the plurality of documents reflecting communications of the specified person;
identifying one or more presumed collaborators of the specified person by analyzing an organizational structure;
merging the list of actual collaborators and the list of presumed collaborators.

4. The method of claim 1, wherein generating the set of questions further comprises:
identifying a category which received a lowest aggregated response value in a previous survey;
identifying, for the identified category, a predefined number of sub-categories which received lowest, among all sub-categories, numbers of answered questions in the previous survey;
generating, for identified sub-category, a predefined number of survey questions.

5. The method of claim 1, wherein generating the set of questions further comprises:
identifying a predefined number of survey categories which received lowest aggregated response values in a previous survey;
identifying, for each identified category, a predefined number of employees which received lowest aggregated response values in the category;
generating, for each of one or more sub-categories in the identified category, a predefined number of survey questions.

6. The method of claim 1, wherein the dashboard visually represents a set of employee experience parameters for a chosen organizational unit.

7. The method of claim 1, wherein the dashboard visually represents a set of employee efficiency parameters for a chosen organizational unit.

8. The method of claim 1, wherein the dashboard visually represents a set of employee skills and corresponding skill levels of the specified person based on responses by one or more members of the collaboration circles.

9. The method of claim 1, wherein the dashboard visually represents a set of employee leadership traits and corresponding leadership trait levels of the specified person based on responses by one or more members of the collaboration circles.

10. A system, comprising:
a memory; and
a processor coupled to the memory, wherein the processor is configured to:
identify, based on processing a plurality of documents reflecting communications of a specified person, a collaboration circle of the specified person;
generate, based on a set of previously collected responses reflecting experience and efficiency of the employee, a set of questions with respect to experience and efficiency of the employee;
present the set of questions to a plurality of persons comprised by the collaboration circle;
collect responses to the set of questions from the plurality of persons comprised by the collaboration circle; and
generate a dashboard reflecting the collected responses.

11. The system of claim 10, wherein identifying the collaboration circle further comprises:
generating a list of actual collaborators by analyzing the plurality of documents reflecting communications of the specified person;
identifying one or more presumed collaborators of the specified person by analyzing an organizational structure;
merging the list of actual collaborators and the list of presumed collaborators.

12. The system of claim 10, wherein generating the set of questions further comprises:
identifying a category which received a lowest aggregated response value in a previous survey;
identifying, for the identified category, a predefined number of sub-categories which received lowest, among all sub-categories, numbers of answered questions in the previous survey;
generating, for identified sub-category, a predefined number of survey questions.

13. The system of claim 10, wherein generating the set of questions further comprises:
identifying a predefined number of survey categories which received lowest aggregated response values in a previous survey;
identifying, for each identified category, a predefined number of employees which received lowest aggregated response values in the category;
generating, for each of one or more sub-categories in the identified category, a predefined number of survey questions.

14. The system of claim 10, wherein the dashboard visually represents at least one of: a first set of employee experience parameters for a chosen organizational unit or a second set of employee efficiency parameters for a chosen organizational unit.

15. The system of claim 10, wherein the dashboard visually represents a set of employee skills and corresponding skill levels of the specified person based on responses by one or more members of the collaboration circles.

16. The system of claim 10, wherein the dashboard visually represents a set of employee leadership traits and corresponding leadership trait levels of the specified person based on responses by one or more members of the collaboration circles.

17. A non-transitory computer-readable storage medium comprising executable instructions that, when executed by a computer system, cause the computer system to:
identifying, by a computer system, based on processing a plurality of documents reflecting communications of a specified person, a collaboration circle of the specified person;
generating, based on a set of previously collected responses reflecting experience and efficiency of the employee, a set of questions with respect to experience and efficiency of the employee;
presenting the set of questions to a plurality of persons comprised by the collaboration circle;
collecting responses to the set of questions from the plurality of persons comprised by the collaboration circle; and
generating a dashboard reflecting the collected responses.

18. The non-transitory computer-readable storage medium of claim 17, wherein identifying the collaboration circle further comprises:
generating a list of actual collaborators by analyzing the plurality of documents reflecting communications of the specified person;
identifying one or more presumed collaborators of the specified person by analyzing an organizational structure;
merging the list of actual collaborators and the list of presumed collaborators.

19. The non-transitory computer-readable storage medium of claim 17, wherein generating the set of questions further comprises:
identifying a category which received a lowest aggregated response value in a previous survey;
identifying, for the identified category, a predefined number of sub-categories which received lowest, among all sub-categories, numbers of answered questions in the previous survey;
generating, for identified sub-category, a predefined number of survey questions.

20. The non-transitory computer-readable storage medium of claim 17, wherein generating the set of questions further comprises:
identifying a predefined number of survey categories which received lowest aggregated response values in a previous survey;
identifying, for each identified category, a predefined number of employees which received lowest aggregated response values in the category;
generating, for each of one or more sub-categories in the identified category, a predefined number of survey questions.
